(19) United States
(12) Patent Application Publication
(10) Pub. No.: US 2010/0117860 A1
(43) Pub. Date: May 13, 2010

(54) TRAFFIC LIGHT WARNING SYSTEM

(76) Inventor: Daniil Alexandrovich Agafonov, Moscow (RU)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/596,763

(22) PCT Filed: Jan. 24, 2008
(86) PCT No.: PCT/RU08/00033

§ 371 Date: Oct. 20, 2009

(30) Foreign Application Priority Data
Jan. 31, 2007 (RU) 2007103684

(51) Int. Cl. G08G 1/095

(52) U.S. Cl. 340/907

(57) ABSTRACT

The invention relates to traffic control and can be used for controlling the traffic of private cars, buses, motorcycles etc, substantially in cities. The aim of said invention is to increase the reliability and the service life of a device and to simplify the structural design thereof The inventive traffic light warning system comprises at least one set consisting of a main traffic signal and at least one additional traffic signal which is placed in a traffic direction prior to the main traffic signal at a specified distance there from. Said additional traffic signal comprises at least one indicating light which is used for duplicating the indications of the corresponding indicating light of the main traffic signal. The indicating lights of the main and additional traffic signals are switched in parallel. The indicating lights of the main and additional traffic signals can be embodied in the form of incandescent lamps or light-emitting diodes or of the combination thereof

This invention relates to a road traffic control and is applicable for controlling mainly an urban traffic of vehicles, buses, motorcycles, etc.

Known is a device for warning vehicles of a railway-crossing, comprising appropriate road signs placed in the direction of traffic.

Also known is a combined traffic signal installation, comprising a polarized light source and a receiving device having a polarizer. The traffic signal installation is provided with at least one polarized light source and at least one receiving and reproducing device comprising a receiving unit and a reproducing unit, the receiving device including two polarizers and two photo sensors mounted after the respective polarizers, the polarization plane of each light source being coincident with the polarization plane of the respective polarizer of the receiving unit, the polarization planes of the paired polarizers being mutually orthogonal, wherein the light sources and the receiving and reproducing devices are disposed on different objects (RU 2076265, Mar. 03, 1997). The disadvantage of this installation consists in that a vehicle has to be equipped with traffic light signaling, and information has to be transmitted to the vehicle, because of which it cannot be used in urban environment, especially with a heavy traffic.

A prior art closest to the proposed invention is a road light signaling system comprising at least one set consisting of a main traffic signal installation and an additional traffic signal installation disposed at a predetermined distance ahead of said main traffic signal installation in the direction of traffic, the additional traffic signal installation having at least one indicating light duplicating the indications of the respective indicating light of the main traffic signal installation (CN 1,308,306, Aug. 15, 2001). The on and off time of the indicating light in the additional traffic signal installation is always earlier than that for the light in the main traffic signal installation, the time difference duration being controlled by a control circuit.

It is advantageous to have an additional traffic signal installation placed ahead of the main one and duplicating its indications to control the urban traffic. However, using the control circuit and controlling the time difference between the on and off time of the main and additional indicating lights results in complicating the claimed device (which leads to a loss in its reliability, a decrease in service life, an increase in cost). At the same time, since there is no need for providing a time shift between the on and off time of the indicating lights in the urban environment, there is no need for using the control circuit.

The technical effect to be achieved by the present invention consists in enhancing its reliability and increasing the service life along with making the device simpler.

This technical effect is achieved by providing a road light signaling system including at least one set comprising a main traffic signal installation and an additional traffic signal installation disposed at a predetermined distance ahead of the main traffic signal installation in the direction of traffic, the additional traffic signal installation having at least one indicating light duplicating the indications of a respective indicating light of the main traffic signal installation, wherein the indicating light of the main traffic signal installation and the at least one duplicating indicating light of the additional traffic signal installation are connected in parallel directly to each other and operate simultaneously.

Either incandescent lamps or light emitting diodes or both types of those indicating light devices may be used as the indicating lights of the main and additional traffic signal installations.

The road light signaling system according to the invention operates as follows.

Upon switching on the main traffic signal installation, the indicating light of the additional traffic signal installation also switches on. Thus, the vehicle drivers' attention is further attracted to the lights, which diminishes the driver's response time, and the probability of a road traffic accident decreases. Moreover, in the event of a failure of the indicating light of the main traffic signal installation, the required signals continue to be transmitted to the drivers by the light of the additional traffic signal installation, due to the parallel and direct connection of those lights.

1. A road light signaling system including at least one set comprising a main traffic signal installation and an additional traffic signal installation disposed at a predetermined distance ahead of said main traffic signal installation in the direction of traffic, said additional traffic signal installation having at least one indicating light duplicating indications of a respective indicating light of said main traffic signal installation, characterized in that said indicating light of the main traffic signal installation and said duplicating indicating light of at least one additional traffic signal installation are connected in parallel directly to each other and operate simultaneously.

2. The system according to claim 1 characterized in that said indicating lights of the main and additional traffic signal installations include incandescent lamps.

3. The system according to claim 1 characterized in that said indicating lights of the main and additional traffic signal installations include light-emitting diodes.

4. The system according to claim 1 characterized in that said indicating lights of the main and additional traffic signal installations comprise incandescent lamps and light-emitting diodes.
